(19) United States
(12) Patent Application Publication
(10) Pub. No.: US 2007/0213942 A1
(43) Pub. Date: Sep. 13, 2007

(54) Method and system for determining the propagation path of at least one crack from one or more fracture surfaces created by said crack(s)

(76) Inventors: Laurent Ponson, Sartrouville (FR); Elisabeth Bouchaud, Paris (FR); Daniel Bonamy, Paris (FR)

Correspondence Address: CLARK & BRODY, 1090 VERMONT AVENUE, NW, SUITE 250, WASHINGTON, DC, 20005, US

(21) Appl. No.: 11/311,280

(22) Filed: Dec. 20, 2005

(30) Foreign Application Priority Data
Oct. 28, 2005 (FR) 0511058

(51) Int. Cl. G01M 19/00; G01B 21/30; G01B 21/20

(52) U.S. Cl. 702/36; 702/179; 702/168

(57) ABSTRACT

The present invention relates to a method and to a system for determining, in a solid structure that has failed along at least one fracture surface, the propagation path of at least one crack at the origin of said or each fracture surface. The method according to the invention comprises a step a) for the acquisition of topographical data for said or each surface either in a case (i) by extraction of height profiles along a plurality of directions or in a case (ii) by acquisition of a height contour map, and with a resolution for which said structure is heterogeneous and rough, which method includes, after this step a), an analysis of the statistical roughness properties of the or each surface that displays an anisotropy of these properties along said plurality of directions, in order to deduce from this anisotropy at least one propagation direction X of the or each crack that defines all or part of said path.

The present invention relates to a method and to a system for determining, in a solid structure that has failed along at least one fracture surface, the propagation path of at least one crack at the origin of the or each fracture surface. The invention applies to all types of solid structures, comprising for example mechanical components of vehicles, decorative or protective constructions of sensitive installations, components or nanocomponents used in new technologies, civil engineering works, or even the Earth's crust.

To determine the cause of a rupture or of a fracture in a solid structure, a fractographic examination may be carried out in a known manner, consisting in inspecting the fracture surface of the structure that has fractured, in order to try to deduce therefrom information about the cause of the fracture. For example, a sequential striation initiated at a change in cross section of a structure may suggest the predominance of a fatigue mechanism, whereas a distortion at the fracture surface may suggest a ductile fracture by an overload, etc. This fractographic examination may be carried out on a macroscopic scale by visual inspection at reduced magnification, by stereoscopic examination or else at very much higher magnifications via a scanning electron microscope (SEM).

A major drawback of these methods of determining the origin of a fracture lies in the lack of reliability of the information obtained, both for certain modes of fracture and for certain materials. In particular, these methods are completely inappropriate for the fracture of brittle materials, such as ceramics, glass, concretes, single-crystal solids, quasicrystals, etc., and also for the fracture of metal alloys by cleavage.

From the founding work of Mandelbrot (B. B. Mandelbrot, D. E. Passoja and A. J. Paullay: “Fractal character of fracture surfaces of metals”, Nature 308, 721-722, 1984), the study of the morphology of fracture surfaces has become a very active field of research. For a wide variety of heterogeneous materials, it has been concluded that the fracture surfaces exhibit universal properties, although the fracture mechanisms on a microscopic scale are very different from one material to another (see E. Bouchaud: “Scaling properties of cracks”, J. Phys. Condens. Matter 9, 4319-4344, 1997). Many experimental studies have in fact suggested that the fracture surfaces are self-affine over a wide range of length scales, that is to say, along a given direction of the surface, the spatial variation of the height-height correlation function:
Δh(Δr)=<(h(r+Δr)−h(r))²>ᵣ^{1/2} (1)
is given by:
Δh/l=(Δr/l)^{H} (2)
where h is the height at the abscissa r, Δh is the mean height difference between two points Δr apart, the average < >ᵣ is carried out over the position of the first point. The exponent H is the Hurst exponent, also called the roughness exponent, and the length l is the topothesy or length scale for which Δh/l is equal to Δr/l.

Some of these studies relating to various types of materials and modes of fracture have concluded that there is a universal and isotropic value H of this Hurst exponent, which would be approximately equal to 0.8. In particular, the following articles may be referred to for detailed reports of these studies:
E. Bouchaud, G. Lapasset and J. Planes: “Fractal dimension of fractured surfaces: A universal value?”, Europhys. Lett. 13, (1990);
K. J. Maloy, A. Hansen, E. L. Hinrichsen and S. Roux: “Experimental measurements of the roughness of brittle cracks”, Phys. Rev. Lett. 68, 213-215, (1992);
J. Schmittbuhl, F. Schmitt and C. Scholz: “Scaling invariance of crack surfaces”, J. Geophys. Res. 100, 5953-5973, (1995); and
P. Daguier, B. Nghiem, E. Bouchaud and F. Creuzet: “Pinning and depinning of crack fronts in heterogeneous materials”, Phys. Rev. Lett. 78, 1062-1065, (1997).

During their research on the statistical roughness properties of self-affine fracture surfaces of solid structures, the inventors sought to analyze topographical data of these surfaces, which data was acquired either in case (i) by extraction of height profiles along a plurality of directions or in case (ii) by acquisition of a height contour map, and in both cases with a resolution for which the structure is heterogeneous and rough (acquisition step a) below), in order to obtain possible anisotropic roughness properties of these surfaces enabling the path of a crack in the structure to be reliably reconstructed.

This objective has just been achieved in that the inventors have discovered, unexpectedly, that taking a point sufficiently far from the crack initiation and independently of the considered material (e.g. whether this be of the brittle, quasi-brittle or ductile type), of the fracture mode (e.g. stress corrosion, fatigue, quasi-static fracture, dynamic fracture) and of the crack propagation velocity, the Hurst exponent calculated parallel to the crack propagation direction has a value β substantially less than its value ζ calculated parallel to the crack front and that, more thoroughly, this anisotropy of the Hurst exponent can be generalized by a specific spatial law of variation of a two-dimensional correlation function of the extracted profiles that involves these two Hurst exponents ζ, β and a third exponent κ, which is approximately equal to ζ/β.

Contrary to the teaching of the existing literature, it should be noted that the inventors have been able to establish that the scaling invariance properties of a self-affine fracture surface are anisotropic, this being so for a wide range of materials and of different fracture modes.

Thus, the method of determination according to the invention, in a solid structure, of all or part of the propagation path of at least one crack that has broken said solid structure over one or more fracture surfaces, includes, from said step a), an analysis of the statistical roughness properties of the or each surface that displays an anisotropy of these properties along a plurality of directions, in order to deduce from this anisotropy at least one propagation direction X of the or each crack that defines all or part of said path.

According to another feature of the invention, said method may comprise, after step a), the following steps:
b) determination:
   either, in respect of said directions in the aforementioned case (i) of step a), of at least one statistical roughness property of said surface that is representative of the spatial variation of a correlation function for the profiles extracted at a) and that includes values of the Hurst exponent of said surface corresponding to said directions respectively,
   or in respect of said map in the aforementioned case (ii) of step a), of at least one statistical roughness property of said surface that is representative of the spatial variation of its correlation function;
c) comparison of the property or properties determined at b) with reference values of said property or properties, which are representative of a spatial reference variation Δh of said correlation function that is specific to crack propagation directions X; and then
d) determination of the propagation direction or directions X for which this comparison displays a similarity between one or more intended properties at b) and c) or between variations of the corresponding functions, which directions define all or part of said propagation path.

It should be noted that, according to the invention, this method of determining the path of a crack applies in general to any type of material, with the exception of a perfect crystal broken at a sufficiently low temperature, so that the fracture surface is coincident with a cleavage plane of this crystal. However, it should be noted that the method of determination according to the invention has been successfully applied to the cleavage of quasicrystals.

It should also be noted that this method according to the invention does not allow the crack propagation direction to be determined directly, rather this direction can be deduced indirectly from the reconstructed path of the crack.

It is preferable to implement the method at various regions, so as to determine the local propagation direction X and to reconstruct the path of the crack back to its origin.

In the case of a structure that has been broken by several cracks, it will be noted that the method according to the invention can be implemented on each of the fracture surfaces.

Step a) for topographical data acquisition may be carried out using 1D or 2D techniques, which correspond to the acquisition of profiles in the form of lines or in the form of contour maps, respectively.

It is essential to note that this topographical data acquisition must be implemented on a scale for which the fracture surface is rough, which scale may in fact range from a few fractions (e.g. a tenth, hundredth or thousandth, depending on the resolution of the device used for the topography acquisition) to a few times (e.g. around ten times) the largest characteristic scale of the microstructure of the constituent heterogeneous material of the structure in question.

In the case of a metallic material, the topographical measurements must be made with a precision or resolution that is at most of the order of one hundredth, or even one thousandth, of the mean grain size, and the topographical measurement obtained advantageously corresponds to a few grains (three or four grains suffice).

For a wooden material, the resolution may correspond to the size of the cells, and for concrete to that of the grains of sand.

For amorphous materials, such as glass or nanoceramics, the topographical measurement is made with a resolution of the typical size of the disorder (e.g. of the order of one billionth of a meter in glass and of a few tens of billionths of a meter in nanoceramics), the measurement size advantageously being equal to around one hundred times this size.

In general, a person skilled in the art will know how to determine the resolution of the measurements, so that those are matched to the size of the microstructures present on the fracture surface of the structure in question.

Preferably, the topography acquisition step a) is in general carried out using a technique chosen from the group consisting of mechanical profilometry (e.g. implemented via a stylus or feeler), optical profilometry (e.g. implemented by interferometric, stereoscopic or confocal techniques coupled to conventional microscopy or scanning electron microscopy) and near-field microscopy (e.g. atomic force microscopy, scanning tunneling microscopy, near-field optical microscopy).

The type of profilometry used will advantageously be matched to the constituent material of the structure being studied. Mechanical profilometry is particularly suitable for materials such as concrete, rock or wood, the stereoscopic method coupled with scanning microscopy is particularly suitable for metals, while near-field microscopy is particularly suitable for amorphous materials, such as glasses, quasicrystals and nanoceramics.

According to a first embodiment of the invention, the correlation functions intended at b) and c) are each one-dimensional functions and the directions X determined at d) are those for which the Hurst exponent has a minimum value β in comparison with that relating to the other directions of said plurality of directions.

This is because the inventors have demonstrated that the Hurst exponent has a value β approximately equal to 0.60 in said propagation directions X of the or each crack, whereas this same Hurst exponent has a value ζ approximately equal to 0.75 in directions z that correspond to the crack front of said or each crack and that are orthogonal to said propagation directions X.

According to this first embodiment of the invention, for a 2D-type topographical measurement to be obtained at step a), the mean plane of the fracture surface is preferably “subtracted”, so as to ensure the average planarity of this surface, and the height profiles are extracted along said plurality of directions. For a 1D-type topographical measurement, the mean slope at each of the profiles obtained is preferably “subtracted” and measurements are made in said plurality of directions. In both cases, said extracted height profiles comprise at least 100 measurement points in each of said plurality of directions.

Next, for each of these directions, the height-height correlation function—for example, of the 1D type—along the profiles is calculated using the aforementioned formula (1) where h is the height at the abscissa r relative to a chosen reference, preferably close to the mean fracture plane. This function varies in the following manner:
Δh(Δr)˜Δr^{H} (3)
where the symbol ˜ means “proportional to” and the exponent H is the Hurst exponent or roughness exponent.

Thus, the Hurst exponent is determined along said plurality of directions, preferably by means of a computer program.

As indicated above with reference to step d), the directions for which the value of this Hurst exponent is a minimum corresponds to the propagation directions X.

It will be noted that the height profiles extracted at step a) must be composed of a sufficient number of points, preferably at least around one hundred points for each of the directions. This is because the number of profiles for any one direction increases the precision of the value of the Hurst exponent H, and to do this it is necessary to average Δh corresponding to a given value of Δr over the set of profiles.

Depending on the precision that it is desired to obtain, the aforementioned measurements and calculations will be carried out on a correspondingly chosen number of directions. For example, with at least 20 chosen directions, the theoretical precision for each propagation direction X will be ±10 degrees or better.

According to a second embodiment of the invention, the correlation functions intended at b) and c) are each two-dimensional functions and are advantageously calculated from a height contour map, and the directions X determined at d) are those for which the spatial variation of the correlation function Δh(ΔZ,ΔX), which is defined by the equation:
Δh(ΔZ,ΔX)=<[h(Z+ΔZ,X+ΔX)−h(Z,X)]²>_{z,x}^{1/2} (4)
is in fact of the form:
Δh(ΔZ,ΔX)=ΔX^{β}f(ΔZ/ΔX^{1/κ}) (5)
where:
ΔZ and ΔX thus correspond to increments along the orthogonal directions Z and X, which correspond to the directions of the crack front of said or each crack and to the propagation directions thereof, respectively:
β is the minimum value of the Hurst exponent in said propagation directions x of the or each crack;
f is a function of ΔZ and ΔX that satisfies the relationship f(u)˜1 if u<<c and f(u)˜u^{ζ} if u>>c, where ζ is the maximum value of the Hurst roughness exponent in the direction Z of the crack front and where c is a constant related to the topothesies l_{X} and l_{Z}, which represent the respective scales for which Δh is equal to ΔX and Δh is equal to ΔZ, Z representing the direction of the crack front orthogonal to the direction X; and
κ is the value of a third exponent defined by κ=ζ/β.

The inventors have in fact verified that this reference variation of the correlation function given at (5) involves the two aforementioned values ζ and β of the Hurst exponent, in the directions Z and X respectively, which are approximately equal to 0.75 and 0.60, and also the third exponent κ, which is approximately equal to 1.25.

In accordance with this second embodiment of the invention, for a 2D-type topographical measurement to be obtained at step a), the mean plane of the fracture surface is preferably “subtracted” so as to ensure the average planarity of this surface. From the profiles resulting from a 1D topographical measurement along said plurality of directions, it is possible to reconstruct a 2D mapping from which the mean plane is preferably “subtracted”.

Next, the spatial variation of the 2D height-height correlation function defined by equation (4) above is calculated and then the orthogonal directions Z and X, corresponding to the crack front direction and to the crack propagation direction respectively, for which the correlation function of the surface varies in accordance with equation (5) above, are determined, preferably by means of a computer program (a map with a minimum of 100 by 100 points is preferable).

According to a preferred example of implementation of the second embodiment of the invention, step d) comprises the following substeps:
(i) the exponents H_{z} and Hₓ and the topothesies l_{z} and lₓ corresponding to the Hurst exponents and to the topothesies defined by the one-dimensional correlation function Δh/l=(Δr/l)^{H} are determined along the horizontal direction z and vertical direction x of the height contour map, respectively;
(ii) the theoretical two-dimensional correlation function Δh^{th}(Δz,Δx)=(Δx/lₓ)^{Hx}f((Δz/l_{z})/(Δx/lₓ)^{Hx/Hz}), is calculated with f given by:
f(u)=lₓ if u<(lₓ/l_{z})^{1/Hz} and f(u)=u^{Hz} if u>(lₓ/l_{z})^{1/Hz} from the numerical values of H_{z}, Hₓ, l_{z} and lₓ calculated in step (i);
(iii) the experimental two-dimensional correlation function Δh^{exp}(Δz,Δx) is calculated from the height contour map;
(iv) the deviation err from the theoretical function to the experimental function is defined by:
   err=<|Δh^{exp}(Δz,Δx)−Δh^{th}(Δz,Δx)|>
   where < > represents the mean over the set of values taken by Δz and Δx, in such a way that err is a positive number;
(v) the height contour map is redefined in a reference frame obtained by rotation through an angle θ from the initial reference frame and steps (i), (ii), (iii) and (iv) are repeated. The magnitude err for each value of θ explored is thus calculated; and
(vi) the minimum of the function err(θ) over θ ranging from 0 to 180° is sought. This has two minima corresponding to θ₁ and θ₂ respectively. Among these two values, that for which H_{Z} measured at step (i) is a minimum corresponds to the propagation direction X and that of the two values for which H_{Z} is a maximum is the direction of the crack front, perpendicular to this propagation direction X.

A system according to the invention for implementing the abovementioned method of determining the crack path comprises:
at least one profilometer suitable for acquiring, along a plurality of directions, either height profiles in the case (i) or a height contour map in the case (ii), at least one fracture surface over which a solid structure has been broken;
first means for the statistical processing of said height profiles in order to determine, for said directions, anisotropic roughness properties of said surface that are representative of the spatial variation of a correlation function for said profiles and that include various values of the Hurst exponent of said surface; and
second means for the statistical processing of said map, in order to compare the properties of its height-height correlation function with the properties of a reference function Δh that are specific to the propagation direction and X of at least one crack at the origin of said or each surface, suitable for determining said directions X for which the property or properties or the corresponding variation of the correlation function is similar to the property or properties or to the variation of said reference function Δh.

The fields of application of said method and said system according to the invention comprise, non-limitingly, structures used in transportation (e.g. the aeronautical field, for example for airplane propellers, aircraft wings or turbines, river or maritime navigation, railroad vehicles or automobiles, etc.), civil engineering constructions (e.g. bridges, buildings, etc.), components used in new technologies (e.g. nanostructures and nanoceramics used in electronics, quasicrystals used in coatings, etc.), handcrafted objects (e.g. those made of marble), Earth crust structures for example, those studied in tectonics or in the oil industry, decorative or protective constructions, for example made of glass (e.g. in the nuclear industry), etc.

It will be understood that the determination of the causes of a structure fracturing, made possible by the method according to the present invention, advantageously enables, where appropriate, the responsibility of each person or party with respect to insurance companies to be apportioned. Knowing the causes of a fracture and the path(s) followed by the crack(s) responsible for the structure fracturing may also allow the design of the structure to be modified, so as to improve the mechanical integrity of similar structures in the future.

The aforementioned features of the present invention, and also others, will be better understood on reading the following description of several exemplary embodiments of the invention, given by way of illustration and implying no limitation, said description being read in conjunction with the appended drawings among which:

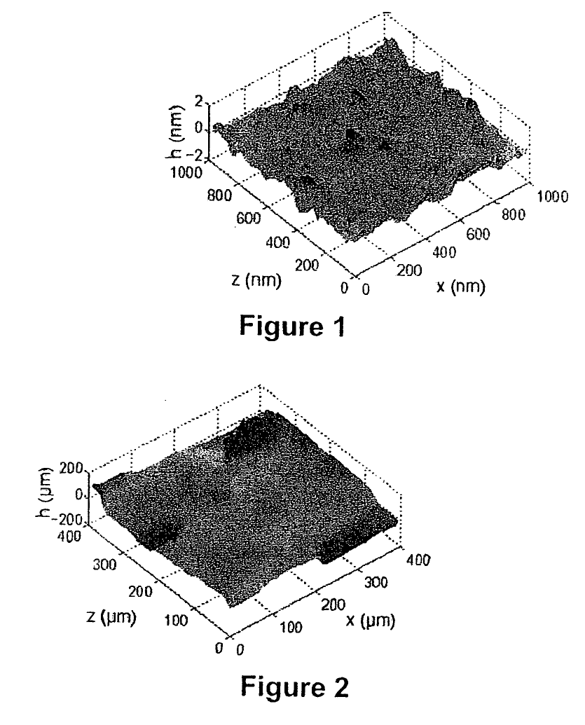

FIG. 1 is a topographical image obtained for a fracture surface of a silica glass structure, along the X and Z axes, namely the directions of propagation of the crack and of the crack front, respectively;

FIG. 2 is a topographical image obtained for a fracture surface of an aluminum alloy structure along the same axes;

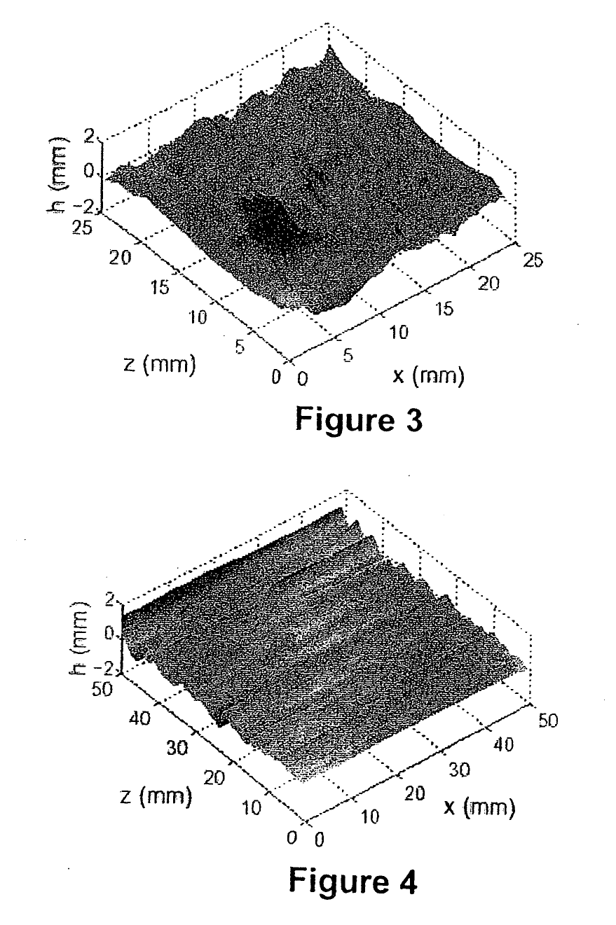

FIG. 3 is a topographical image obtained for a fracture surface of a mortar structure along the same axes;

FIG. 4 is a topographical image obtained for a fracture surface of a wooden structure along the same axes;

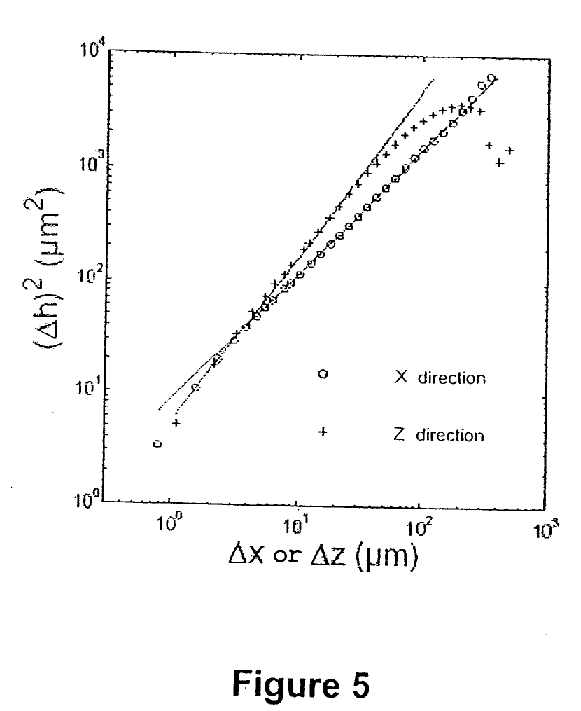

FIG. 5 is a graph illustrating, for a fracture surface in an aluminum alloy, the two separate variations of the 1D height-height correlation function that are measured parallel to the crack propagation direction and parallel to the crack front, respectively;

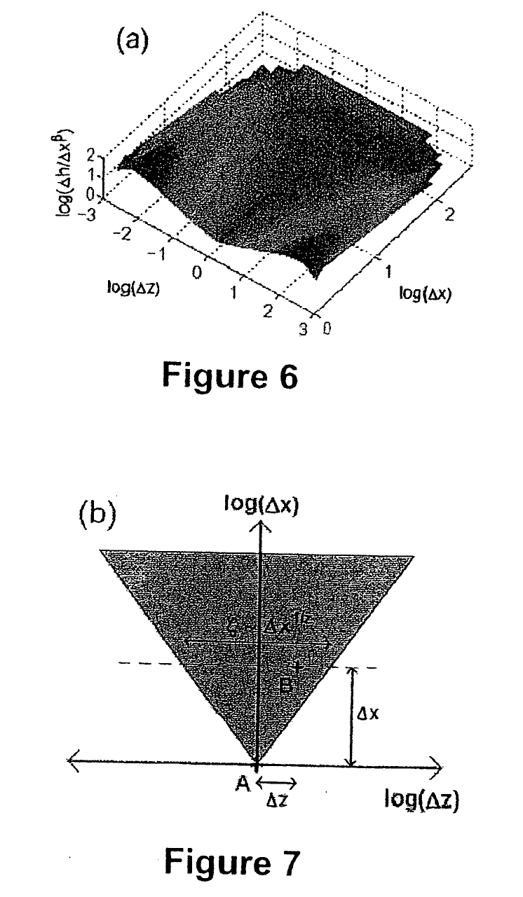

FIG. 6 is a three-dimensional representation of the height-height correlation function for a fracture surface in an aluminum alloy, Δh being normalized by ΔX^{β};

FIG. 7 is a two-dimensional representation, in the plane (ΔZ, ΔX), of regions situating the two different types of variation of the height-height correlation function illustrated in FIG. 6,

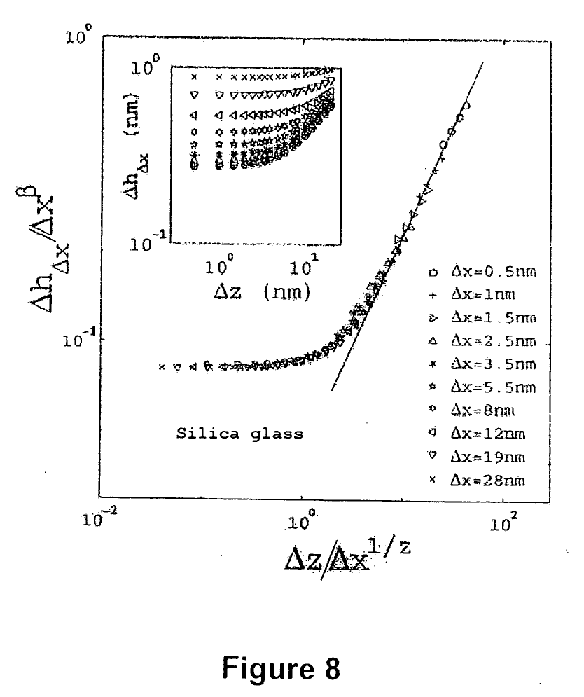

FIG. 8 is a graph illustrating the variations along ΔZ, for various values of ΔX, of the 2D correlation function normalized by ΔX^{β} relative to the silica glass fracture surface illustrated in FIG. 1;

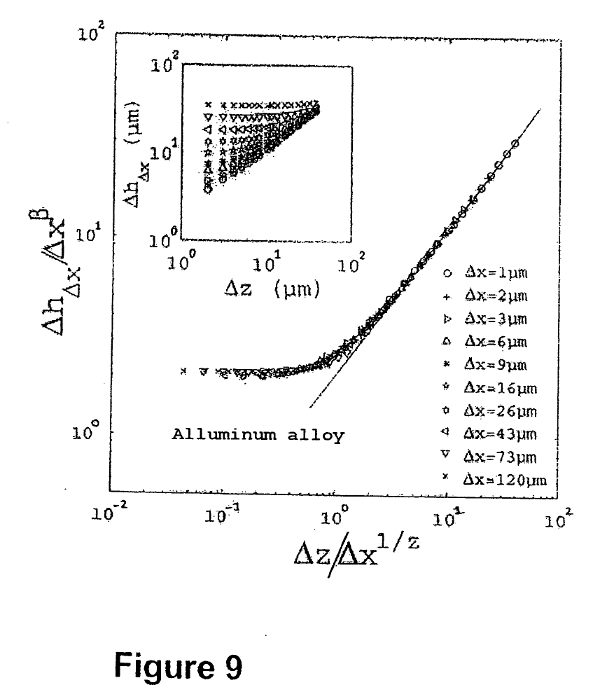

FIG. 9 is a graph illustrating the variations along ΔZ, for various values of ΔX, of the 2D correlation function normalized by ΔX^{β} for the aluminum alloy fracture surface illustrated in FIG. 2;

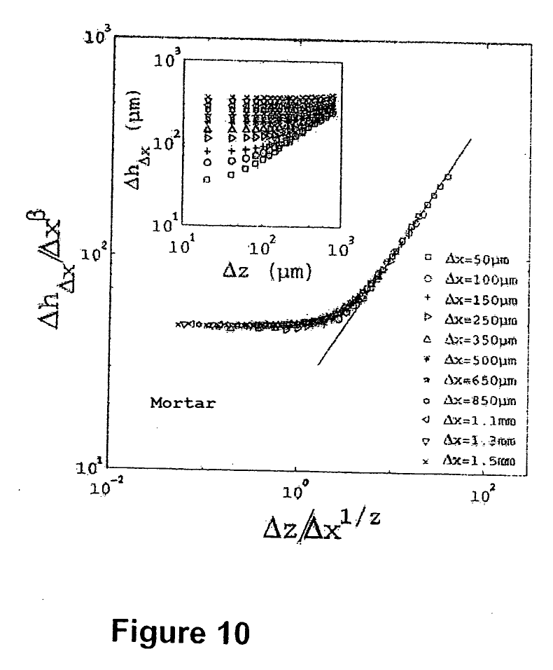

FIG. 10 is a graph illustrating the variations along ΔZ, for various values of ΔX, of the 2D correlation function normalized by ΔX^{β} for the mortar fracture surface illustrated in FIG. 3; and

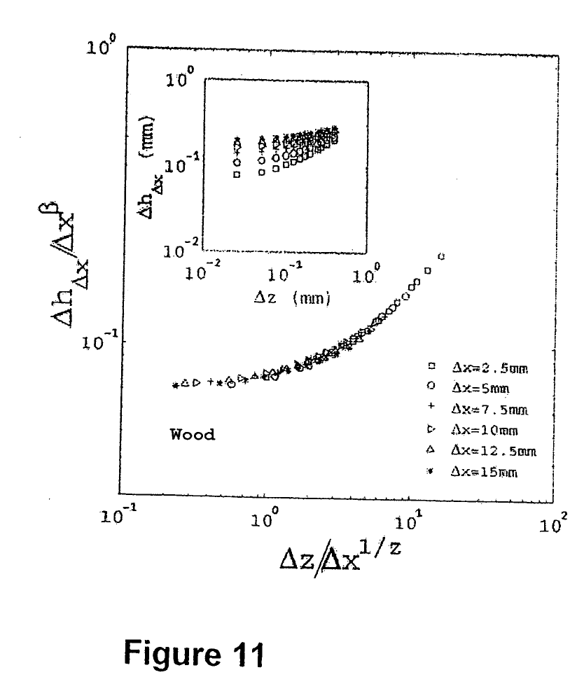

FIG. 11 is a graph illustrating the variations along ΔZ, for various values of ΔX, of the 2D correlation function normalized by ΔX^{β} for the fracture surface in wood illustrated in FIG. 4.

The experimental report that follows seeks to evidence the anisotropic statistical roughness properties relating to fracture surfaces of four different materials, which have different microstructure characteristic sizes respectively, namely silica glass as a brittle material, an aluminum alloy as a ductile material, and mortar and wood as quasi-brittle materials (these being isotropic and anisotropic respectively).

These four respective materials were broken by different mechanical fracture tests and then topographical measurements of the fracture surfaces were obtained via three different techniques.

### Description of the Fracture Tests and the Methods of Measuring the Topography of the Fracture Surfaces

1) Fracture surfaces of a silica glass structure, such as the one illustrated in FIG. 1, were obtained by fracturing parallelepipedal specimens, measuring 5×5×25 mm³ in a DCDC (Double Cleavage Drilled Compression) test configuration, starting from a hole drilled in the specimen, two symmetrical cracks propagating by stress corrosion. For a complete description of this fracture mode, the reader may refer to the article by S. Prades, D. Bonamy, D. Dalmas, E. Bouchaud and E. Guillot: “Nano-ductile crack propagation in glasses under stress corrosion: spatio-temporal evolution of damage in the vicinity of the crack tip”, Int. J. Solids Struct. 42, 637-645, (2004).

After an initial regime in which the propagation is dynamic, the crack propagates under stress corrosion at a low velocity. This velocity has been measured by imaging the propagation in real time by AFM (atomic force microscopy). In the stress corrosion regime, the crack propagation velocity was controlled by adjusting the compressive load. The protocol is then the following:
(i) a large load is applied in order to achieve a high crack velocity;
(ii) the load is reduced to a value below the initially desired value; and then
(iii) the load is increased again up to the value corresponding to the desired velocity and then kept constant.

This procedure made it possible to observe, on the post mortem fracture surfaces, constant-velocity regions clearly separated by arrest lines. Topographical measurements of the fracture surfaces were then made using AFM with a lateral resolution and a vertical resolution of 5 nm and 0.1 nm respectively. To ensure that there was no bias due to the scanning direction of the AFM tip, each image was recorded along two perpendicular directions and the analyses presented below were performed on both sets of images. The images are formed from 1024×1024 pixels and represent a square field having sides of 1 μm.

2) Fracture surfaces of a 7475 commercial aluminum alloy structure, such as the one illustrated in FIG. 2, were obtained using CT (compact tension) specimens, firstly precracked in fatigue and then fractured by applying a uniaxial load in tension thereto.

The fracture surfaces were observed in this second regime using SEM (scanning electron microscopy) at two different tilt angles. High-resolution topographical maps were generated from stereo pairs, using a reconstruction technique based on the cross-correlation of the two images. For further details, the reader may refer to the article by J. J. Amman and E. Bouchaud: “Characterization of self-affine surfaces from 3D digital reconstruction”: Eur. Phys. J. AP 4, 133-142 (1998). The map reconstructed in this way represents a rectangle measuring 565×405 μm² and is made of 512×512 pixels. The resolution is around 2 to 3 μm both in and out of the fracture plane.

3) The fracture surfaces of a mortar structure, such as the one illustrated in FIG. 3, were obtained by 4-point bending tests, resulting in fracture in tension. The displacement was monitored during the test. The length of the beam was 1400 mm and its height 140 mm.

The topography of the fracture surface was recorded using an optical profilometer. The maps consisted of 500 profiles each of 4096 points, the first profile being close to the initial notch. The acquisition step along the profiles was 20 μm. Two successive profiles were separated by 50 μm along the crack propagation direction. The vertical and lateral resolution was around 5 μm.

A transient regime was observed by post mortem analysis of the fracture surfaces. Over the first 10 millimeters traveled by the crack, corresponding to the first 200 profiles, the roughness increased with the distance from the initial notch. For a full description of the statistical properties of the roughness in this region, the reader may refer to the article by G. Mourot, S. Morel, E. Bouchaud and G. Valentin: “Anomalous scaling of mortar fracture surfaces”: Phys. Rev. E 71, 016136-1-016136-7, (2005).

The area of interest here is the morphology of this mortar surface in a region remote from the crack initiation, and the first 200 profiles were systematically eliminated from the maps under investigation.

4) The fracture surfaces of a wooden structure, such as the one illustrated in FIG. 4, were obtained using modified TDCB (Tapered Double Cantilever Beam) specimens subjected to uniaxial tension with a constant crack-opening displacement rate. For further details, the reader may refer to the article by S. Morel, G. Mourot and J. Schmittbuhl: “Influence of the specimen geometry on R-curve behavior and roughening of fracture surfaces”: Int. J. Frac. 121, 23-42, (2003). The material studied was spruce wood (i.e. Picea excelsa), which is highly anisotropic.

The specimen thus fractured in tension. The crack propagated along the longitudinal direction of the wood. Consequently, the observed characteristic lengths on the fracture surfaces were highly anisotropic, being of the order of a few mm and a few tens of μm in the longitudinal and transverse directions respectively. These values corresponded to the length and the diameter of the wood cells, respectively.

To match these scales, the topography of the fracture surfaces was scanned using an optical profilometer over a 50×50 mm² area with higher resolution in the transverse direction (25 μm) than in the longitudinal direction (2.5 mm). The topographical map obtained contained 50 profiles parallel to the crack front direction, each containing 2048 points. As in the case of the mortar fracture surfaces, the topography was obtained far from the initial precrack, i.e. at about 50 mm therefrom, so that the roughness was statistically stationary in the investigated region.

### Topographical Images Obtained for These Four Materials

For greater clarity, the fracture surfaces illustrated in FIGS. 1 to 4 respectively correspond to square regions. The Z axis and the X axis represent the crack front direction and the crack propagation direction respectively.

In the four cases, the axes of the coordinate system are (eₓ,e_{y},e_{z}) in such a way that eₓ and e_{z} are along the crack propagation direction and the crack front direction, respectively. The height h of the relief at a given point is then measured along the e_{y} axis.

It should be noted that the surfaces topographically scanned in this way are visually very different from one another: the characteristic lengths of the reliefs in the fracture plane (along the X and Z axes) and out of this plane (along the height h) depend strongly on the material in question. These lengths are around 50 nm and 1 nm for the silica glass, approximately 100 μm and 30 μm for the aluminum alloy and 5 and 0.6 mm for the mortar.

The fracture surface of the wood is highly anisotropic: in the fracture plane, the reliefs are around 50 and 1 mm respectively along the longitudinal direction (X axis) and transverse direction (Z axis) and around 200 μm out of the fracture plane.

### 1D Analysis of the Height-Height Correlation Function

To study the anisotropy of these fracture surfaces, the 1D height-height correlation function was calculated for each material:
Δh(ΔZ)=<(h(Z+ΔZ,X)−h(Z,X))²>^{1/2} in the Z direction and
Δh(ΔX)=<(h(Z,X+ΔX)−h(Z,X))²>^{1/2} in the X direction.

The variation of these functions has been represented in FIG. 5, for a fracture surface of an aluminum alloy specimen.

The curves in FIG. 5 clearly indicate that the statistical properties of the surface depend on the direction of the profiles studied, although these are self-affine both in the propagation direction (X axis) and in the crack front direction (Z axis). This anisotropy is present not only in the correlation length and the amplitude of the roughness but also in the value of the Hurst exponent, which is the slope of the curve.

The straight lines shown in FIG. 5 correspond to the power laws that fit the experimental points as closely as possible. The slopes of these straight lines, i.e. the exponents of the power laws, are given below.

Along the crack front, this Hurst exponent is found to have a value ζ=0.75±0.03, i.e. substantially in agreement with the “universal” value of the roughness exponent H=0.8 reported in the literature, as indicated above with reference to the prior art.

Parallel to the propagation direction, this Hurst exponent is found to have a value β=0.58±0.03, i.e. significantly lower than the value of ζ obtained in the perpendicular direction.

In conclusion, it is possible to determine the crack propagation direction X corresponding to a minimum value of the Hurst exponent (approximately 0.60).

### 2D Analysis of the Height-Height Correlation Function

The existence of two very different power laws respectively along two different directions in the aforementioned aluminum alloy fracture surface (cf. FIG. 5) led the inventors to carry out a 2D analysis of the height-height correlation function defined by equation (4) above:
Δh(ΔZ,ΔX)=<[h(Z+ΔZ,X+ΔX)−h(Z,X)]²>_{Z,X}^{1/2}.

FIG. 6 gives a color-scale representation of Δh in the plane (ΔZ,ΔX) of this aluminum alloy. The function Δh has been normalized by Δx^{β}, and the axes are logarithmically scaled so as to bring out the anisotropy of the power laws of this function Δh.

FIG. 7, derived from FIG. 6, clearly shows two separate types of behavior of the 2D correlation function depending on the orientation of the vector A̅B̅ of coordinates (ΔZ,ΔX). The gray region corresponds to a variation of the correlation function as Δh˜ΔX^{β}, this function containing information about the statistical properties of the morphology of the fracture surface in all directions.

More precisely, if the vector A̅B̅ lies within the gray region of FIG. 7—which corresponds to the central dark region in FIG. 6—then the 2D correlation function varies as the power law Δh˜ΔX^{β} and does not depend on ΔZ. In this logarithmic scale, the boundaries of this region are straight lines. This means that the width ζ (cf. FIG. 7) of this region increases as the power law: ζ˜ΔX^{1/κ}, where κ≈1.26.

In other words, a region expands from a point A on the fracture surface, a domain where the 2D correlation function varies as ΔX^{β}, develops over a width Δz=ζ increasing as ΔX^{1/κ} (the crack propagating parallel to the X axis).

Outside of this domain, the 2D correlation function depends both on ΔX and on ΔZ. If ΔX=0, the correlation function corresponds to that represented in FIG. 5 and varies as Δh˜Δz^{ζ}, with ζ=0.75. This variation cannot be seen in FIG. 6 because of the divergence of the normalization term ΔX^{β}.

Consequently, the inventors have established that it is possible to account for such behavior of the 2D correlation function of the fracture surface as indicated by the aforementioned equation (5):
Δh(ΔZ,ΔX)=ΔX^{β}f(ΔZ/ΔX^{1/κ}) (5)
where f(u)˜1 if u<<c and f(u)˜u^{ζ}if u>>c and where the constant c is related to the topothesies l_{X} and l_{Z} defined along X and Z respectively.

FIGS. 8 to 11 illustrate, for the four respective aforementioned materials, the variations along ΔZ for various values of ΔX of the normalized 2D correlation function Δh_{ΔX}.

The graphs in these FIGS. 8 to 11 demonstrate that the correlation function in each of the four surfaces investigated is represented by the above equation (5). This is because, for suitable values of β and κ, it may be seen in each main graph that, by normalizing the abscissas by ΔX^{1/κ} and the ordinates by ΔX^{β}, all the curves reduce to a single master curve. As expected from the above equation (5), this master curve is characterized by a plateau and is followed by a power law variation with an exponent ζ. The exponents β and κ are determined by optimizing the overlap of the curves, whereas the exponent ζ is determined as being the exponent of the power law which best fits the variations in the large scales of the master curve.

These three independently determined exponents are given in Table 1 below for each of these four materials. These exponents ζ, β, κ can be likened, respectively, to a roughness exponent, a growth exponent and a dynamic exponent. The fourth column of this table gives the ratio of ζ to β. The error bars correspond to a 95% confidence range.

TABLE 1

| | ζ | β | κ | ζ/β |
|---|---|---|---|---|
| Silica glass | 0.77 ± 0.03 | 0.61 ± 0.04 | 1.30 ± 0.15 | 1.26 |
| Aluminum alloy | 0.75 ± 0.03 | 0.58 ± 0.03 | 1.26 ± 0.07 | 1.29 |
| Mortar | 0.71 ± 0.06 | 0.59 ± 0.06 | 1.18 ± 0.15 | 1.20 |
| Wood | 0.79 ± 0.05 | 0.58 ± 0.05 | 1.25 ± 0.15 | 1.36 |

It has therefore been established that the three aforementioned exponents are ζ≈0.75, β≈0.60 and κ≈1.25, independently of the material and of the crack propagation velocity, from the very low velocity regime in stress corrosion (picometers per second) to the dynamic regime (kilometers per second). It should be noted that the exponent κ satisfies the equation κ=β/ζ.

In conclusion, it is possible to determine the direction X of a crack propagation which corresponds to the fact that the 2D correlation function of the considered fracture surface follows the power law of equation (5) above, with the aforementioned values of the three exponents ζ, β and κ.

1. A method of determining, in a solid structure, all or part of the propagation path of at least one crack that has fractured said solid structure over one or more fracture surfaces, said method including a step a) for the acquisition of topographical data for said or each surface either in a case (i) by extraction of height profiles along a plurality of directions or in a case (ii) by acquisition of a height contour map, and in both cases with a resolution for which said structure is heterogeneous and rough, which method includes, after this step a), an analysis of the statistical roughness properties of the or each surface that displays an anisotropy of these properties along said plurality of directions, in order to deduce from this anisotropy at least one propagation direction X of the or each crack that defines all or part of said path.

2. The method as claimed in claim 1, which comprises, after step a), the following steps:
b) determination:
either, in respect of said directions in case (i), of at least one statistical roughness property of said surface that is representative of the spatial variation of a correlation function for the profiles extracted at a) and that includes values of the Hurst exponent of said surface corresponding to said directions respectively,
or in respect of said map in case (ii), of at least one statistical roughness property of said surface that is representative of the spatial variation of its correlation function;
c) comparison of the property or properties determined at b) with reference values of said property or properties, which are representative of a spatial reference variation Δh of said correlation function that is specific to crack propagation directions X; and then d) determination of the propagation direction or directions X for which this comparison displays a similarity between one or more intended properties at b) and c) or between variations of the corresponding functions, which directions define all or part of said propagation path.

3. The method as claimed in claim 2, wherein the correlation functions intended at b) and c) are each one-dimensional functions and wherein the directions X determined at d) are those for which the Hurst exponent has a minimum value β in comparison with that relating to the other directions of said plurality of directions.

4. The method as claimed in claim 3, wherein the Hurst exponent has a value β approximately equal to 0.60 in said propagation directions X of said or each crack.

5. The method as claimed in claim 4, wherein the Hurst exponent has a value ζ approximately equal to 0.75 in directions z that correspond to the crack front of said or each crack and that are orthogonal to said propagation directions X.

6. The method as claimed in claim 2, wherein the correlation functions intended at b) and c) are each two-dimensional functions and are calculated from said height contour map in case (ii) and wherein the directions X determined at d) are those for which the spatial variation of the correlation function is of the form:
Δh(ΔZ,ΔX)=ΔX^{β}f(ΔZ/ΔX^{1/κ})
where:
ΔZ and ΔX correspond to increments along the orthogonal directions Z and X corresponding to the directions of the crack front of said or each crack and to the propagation directions thereof, respectively:
β is the minimum value of the Hurst exponent in said propagation directions X of the or each crack;
f is a function of ΔZ and ΔX that satisfies the relationship f(u)˜1 if u<<c and f(u)˜u^{ζ} if u>>c, where ζ is the maximum value of the Hurst roughness exponent in the direction Z of the crack front and where c is a constant related to the topothesies l_{X} and l_{Z}, which represent the respective scales for which Δh is equal to ΔX and Δh is equal to ΔZ, where Z represents the direction of the crack front orthogonal to the direction X; and
κ is the value of a third exponent defined by κ=ζ/β.

7. The method as claimed in claim 6, wherein the Hurst exponent has values ζ and β in said directions Z and X that are approximately equal to 0.75 and 0.60 respectively, the exponent κ being approximately equal to 1.25.

8. The method as claimed in claim 6, wherein step d) comprises the following substeps applied to said height contour map:
(i) the exponents ^{l}H_{z} and Hₓ and the topothesies l_{z} and lₓ corresponding to the Hurst exponents and to the topothesies defined by the one-dimensional correlation function Δh/l=(Δr/l)^{H} are determined along the horizontal direction z and vertical direction x of the height contour map, respectively;
(ii) the theoretical two-dimensional correlation function Δh^{th}(ΔZ,ΔX)=(Δx/lₓ)^{Hx}f((Δz/l_{z})/(Δx/lₓ)^{Hx/Hz}), is calculated with f given by:
f(u)=lₓ if u<(lₓ/l_{z})^{1/Hz} and f(u)=u^{Hz} if u>(lₓ/l_{z})^{1/Hz}
from the numerical values of H_{z}, Hₓ, l_{z} and lₓ calculated in step (i);
(iii) the experimental two-dimensional correlation function Δh^{exp}(Δz,Δx) is calculated from the height contour map;
(iv) the deviation err from the theoretical function to the experimental function is defined by:
err=<|Δh^{exp}(Δz,Δx)−Δh^{th}(Δz,Δx)|>
where < > represents the mean over the set of values taken by Δz and Δx, in such a way that err is a positive number;
(v) the height contour map is redefined in a reference frame obtained by rotation through an angle 0 from the initial reference frame and steps (i), (ii), (iii) and (iv) are repeated so as to calculate the magnitude err for each value of θ explored; and
(vi) the minimum of the function err(θ) over θ ranging from 0 to 180° is sought, which has two minima corresponding to θ₁ and θ₂ respectively and, among these two values, that for which H_{Z} measured at step (i) is a minimum corresponds to the propagation direction X and that of the two values for which H_{Z} is a maximum is the direction of the crack front, perpendicular to this propagation direction X.

9. The method as claimed claim 1, wherein:
in case (i) of step a), said height profiles extracted at a) comprise at least 100 measurement points for each of said plurality of directions, which therefore comprises at least 20 different directions, in order to obtain an accuracy in the determination of said propagation directions X that is equal to ±10 degrees or better; and
in case (ii) of step a), said height contour map extracted at a) comprises at least 100 points by 100 points.

10. The method as claimed in claim 1, wherein the topography acquisition step a) is carried out using a technique chosen from the group consisting of mechanical profilometry, optical profilometry and near-field microscopy.

11. A system for implementing the method as claimed in claim 1, which comprises:
at least one profilometer suitable for acquiring, along a plurality of directions, either height profiles in said case (i) or a height contour map in said case (ii), at least one fracture surface over which a solid structure has been broken;
first means for the statistical processing of said height profiles in order to determine, for said directions, anisotropic roughness properties of said surface that are representative of the spatial variation of a correlation function for said profiles and that include various values of the Hurst exponent of said surface; and
second means for the statistical processing of said height contour map, in order to compare the properties of its height-height correlation function with the properties of a reference function Δh that are specific to the propagation direction X of at least one crack at the origin of said or each surface, these second means being suitable for determining said directions X for which the property or properties or the corresponding variation of the correlation function is similar to the property or properties or to the variation of said reference function Δh.

12. The system as claimed in claim 11, wherein said profilometer is chosen from the group consisting of mechanical profilometers, optical profilometers and near-field microscopes.

13. The method as claimed in claim 7, wherein step d) comprises the following substeps applied to said height contour map:
(i) the exponents H_{z} and Hₓ and the topothesies l_{z} and lₓ corresponding to the Hurst exponents and to the topothesies defined by the one-dimensional correlation function Δh/l=(Δr/l)^{H} are determined along the horizontal direction z and vertical direction x of the height contour map, respectively;
(ii) the theoretical two-dimensional correlation function Δh^{th}(ΔZ,ΔX)=(Δx/lₓ)^{Hx}f((Δz/l_{z})/(Δx/lₓ)^{Hx/Hz}), is calculated with f given by:
f(u)=lₓ if u<(lₓ/l_{z})^{1/Hz} and f(u)=u^{Hz} if u>(lₓ/l_{z})^{1/Hz}
from the numerical values of H_{z}, Hₓ, l_{z} and lₓ calculated in step (i);
(iii) the experimental two-dimensional correlation function Δh^{exp}(Δz,Δx) is calculated from the height contour map;
(iv) the deviation err from the theoretical function to the experimental function is defined by:
err=<|Δh^{exp}(Δz,Δx)−Δh^{th}(Δz,Δx)|>
where < > represents the mean over the set of values taken by Δz and Δx, in such a way that err is a positive number;
(v) the height contour map is redefined in a reference frame obtained by rotation through an angle θ from the initial reference frame and steps (i), (ii), (iii) and (iv) are repeated so as to calculate the magnitude err for each value of θ explored; and
(vi) the minimum of the function err(θ) over θ ranging from 0 to 180° is sought, which has two minima corresponding to θ₁ and θ₂ respectively and, among these two values, that for which H_{Z} measured at step (i) is a minimum corresponds to the propagation direction X and that of the two values for which H_{Z} is a maximum is the direction of the crack front, perpendicular to this propagation direction X.
